(19) United States
(12) Patent Application Publication
(10) Pub. No.: US 2007/0295799 A1
(43) Pub. Date: Dec. 27, 2007

(54) Reusable identification system and method

(76) Inventors: Adi Chibel, Holon (IL); Amir Rosman, Ramat-Gan (IL)

Correspondence Address: FISH & RICHARDSON, P.C., PO BOX 1022, MINNEAPOLIS, MN, 55440-1022, US

(21) Appl. No.: 11/475,471

(22) Filed: Jun. 27, 2006

(51) Int. Cl. G06F 17/00; G06Q 30/00

(52) U.S. Cl. 235/375; 235/385

(57) ABSTRACT

A method of receiving identification information identifying a physical object is described. The method includes receiving identification information from an identification capture system that obtains the identification information from an identification component associated with a physical object. The identification information identifies the physical object to which the identification component has been associated. The identification information is encoded in a format compatible with an input device for the identification capture system. The method also includes determining a software object predefined by a process flow to receive the identifier information. The software object has at least one field to store the identifier information. The method also includes identifying a format used for the at least one software object field, and converting the format compatible with the input device of the identification capture system into the format of the at least one software object field.

### TECHNICAL FIELD

The instant specification relates to a reusable identification system and method.

### BACKGROUND

There exist systems for computerized automation of operations and processes in industrial or other commercial enterprises. Examples of such existing systems are those available from SAP AG in Walldorf (Baden) Germany. Some of the existing systems are intended for use with the logistic procedures and operations that are common in manufacturing processes and they are therefore typically used in production plants. Other systems, or components of systems, are intended for use in the logistic management of products that have already been manufactured. They are therefore typically used in warehouses, distribution centers and other facilities where goods may be inspected, repacked and moved to particular storage locations while awaiting shipment.

Some current systems track inventory used in the production plants and storage facilities using radio frequency identification tags or bar codes affixed to the inventory. The systems have logic coupled to user interface (UI) components that decode the information and transmit it to database objects for storage. Incorporating the logic into the UI components, however, may increase the complexity of adding additional decoding schemes because every UI component may need to be modified to support the additional decoding schemes.

### SUMMARY

The present specification relates to systems and methods for receiving and transmitting identification information that identifies a physical object.

In one general aspect, a method of receiving identification information identifying a physical object is described. The method includes receiving identification information from an identification capture system that obtains the identification information from an identification component associated with a physical object. The identification information identifies the physical object to which the identification component has been associated. The identification information is encoded in a format compatible with an input device for the identification capture system.

The method also includes determining a software object predefined by a process flow to receive the identifier information. The software object has at least one field to store the identifier information. The method also includes identifying a format used for the at least one software object field, and converting the format compatible with the input device of the identification capture system into the format of the at least one software object field, and forwarding the identification information in the converted format to the at least one software object field for storage.

In a second general aspect, a method for transmitting identification information identifying a physical object is described. The method includes determining a software object specified by a process flow. The software object having one or more fields to store identification information to be encoded in an identification component using an identification generation system. The identification information identifies a physical object that is associated with the identification component. The method also includes receiving the identification information in a format compatible with the one or more software object fields, and identifying a format used by the identification generation system to encode the identification information in the identification component.

The method also includes converting the format compatible with the one or more software object fields into the format used by the identification generation system, and forwarding the converted identification information to the identification generation system for encoding in the identification component.

In a third general aspect, a system for receiving and transmitting identification information identifying a physical object is described. The system includes a sensor system to receive identification information encoded in an identification component associated with a physical object and to transmit the identification information to the identification component. The identification information identifies the physical object to which the identification component is associated.

The system also includes an encoder to receive the identification information from a software object determined from multiple software objects. The software object has one or more fields to store the identification information in a first format compatible with the software object fields. The encoder also encodes the first format into a predetermined second format used by the sensor system to transmit the identification information to the identification component. Additionally, the system includes a decoder to determine the software object from multiple software objects to receive the identification information encoded the second format from the sensor system, and to decode the second format into the first format used by the one or more fields of the determined software object.

The systems and techniques described here may provide one or more of the following advantages. First, a system may increase efficiency in development of new database objects that can use decoding and encoding services despite not directly providing the services themselves. Second, a system may simplify design by centralizing the decoding and encoding functions into a component that can be used by a variety of database objects. Third, a system may increase quality of service by guiding workers through a validation process. Fourth, a system may decrease inefficiencies in updating decoding and encoding functionalities created by distributing the functionality over a wide variety of database objects. Fifth, a system may seamlessly use decoding and encoding service via multiple technologies.

The details of one or more embodiments of the reusable identification feature are set forth in the accompanying drawings and the description below. Other features and advantages of the feature will be apparent from the description and drawings, and from the claims.

### DESCRIPTION OF DRAWINGS

FIG. 1 is a schematic of an exemplary system to decode bar code information using a mobile reader.

FIG. 2 is a schematic of an exemplary system that includes a reusable identifier module that decodes sensor input.

FIG. 3 is a block diagram of an exemplary system to encode information on an RFID tag using a mobile device.

FIG. 4 is a block diagram of an exemplary system that includes a reusable identifier module that encodes data for output to devices.

FIG. 5A is a flow chart of an exemplary method for decoding received sensor data.

FIG. 5B is a flow chart of an exemplary method for encoding data for output.

FIG. 6 is a schematic diagram of a general computer system.

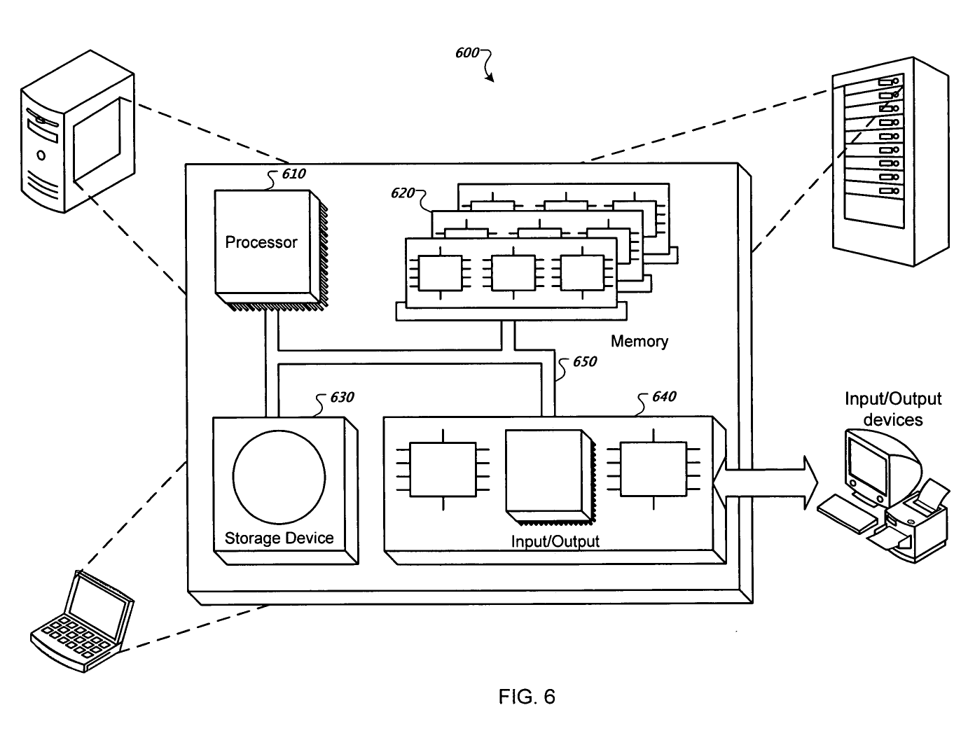

Like reference symbols in the various drawings indicate like elements.

### DETAILED DESCRIPTION

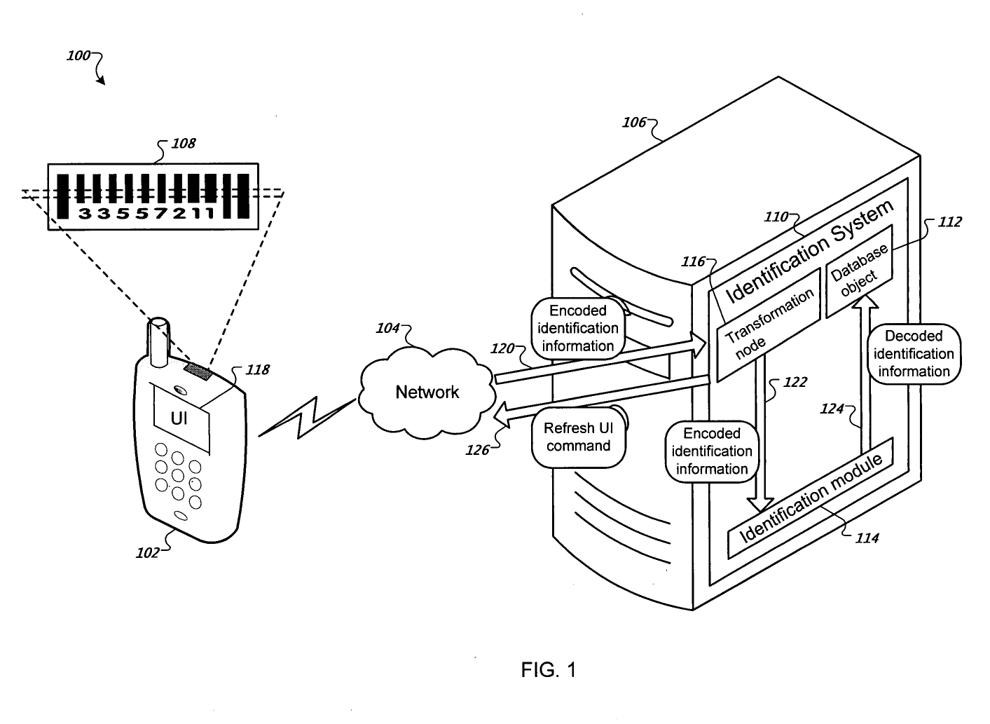

FIG. 1 shows a system for identifying objects, such as stock or locations for storing stock, in a logistic sites including warehouses and production facilities. The system can identify objects automatically using radio frequency identification (RFID) tags, bar codes, or manual input entered by workers. The system of FIG. 1 can receive the input (e.g., RFID or manually entered input), decode it, and store it in a data structure used by the system to manage inventory. Decoding logic can be decoupled from particular user interface (UI) components used to accept or receive the input by including the decoding functionality in a reusable component (e.g., the identification module) that is accessible to multiple UI components.

In addition, the reusable component can include encoding functionality for encoding information stored in the data structure into a format that can be used to identify the object. For example, information can be retrieved from the data structure, encoded into a bar code format, and the bar code information can be transmitted to a printer for printing. A worker can then affix the printed bar code to a physical object, such as a case of cell phones.

Centralizing the decoding and encoding functions in a manner that isolates them from the data structure and the UI components can facilitate enhancing the functions with additional encoding or decoding schemes without requiring extensive revisions to the portions of the system outside of the reusable component. Additionally, centralizing the decoding and encoding functionality provides a uniform mechanism for handling the RFID input, barcode input, manual input, and inputs added in the future.

FIG. 1 is a block diagram of an exemplary system 100 that includes the reusable component with decoding and encoding functionality. In this example, the system 100 decodes bar code information using a mobile reader. The system 100 can include a mobile device 102, having a UI 118, a network 104, and a computer device 106. The mobile device 102 can be used to read a bar code 108. The encoded data read from the bar code 108 can include encoded identification information. For example, the encoded identification information can include identifiers specifying symbolic codes associated with particular products, cases of products, or palettes of products in a warehouse. The computer device 106 can receive the encoded identification information using the network 104 as indicated by arrow 120. The computer device 106 can include an identification system 110, which can include a database object 112, an identification module 114, and a transformation node 116.

The identification system 110 can include modules (e.g., hardware or software) used for decoding the encoded identification information provided by the mobile device 102 to the computer device 106. The transformation node 116 of the identification system 110 can receive the encoded identification information. The identification module 114 can then decode the received encoded identification information as indicated by arrow 122. The decoded identification information can be stored in the database object 112 for future use by the identification system 110 as indicated by arrow 124. After completion of the storage of the decoded identification information, the computer device 106, using the network 104 as indicated by arrow 126, can send a refresh user input (UI) command to the mobile device 102. The command prompts the UI 118 of the mobile device 102 to refresh so that the user can read the decoded input displayed on the mobile device 102.

For example, a vendor can send an advanced shipping notification (ASN) to a buyer's logistics site (e.g., the buyer's warehouse or supermarket). The receipt of the shipping notification may initiate a process flow, which may include a series of operations to accomplish tasks at the logistic site. For example, the receipt of the ASN may cause a system managing the logistics site to initiate a “receive stock” process flow, which can, in turn, includes several smaller process flows, such as an “unload” process flow and a “move” process flow.

In response to the initiation of the receive stock process flow, the system managing the logistic site can generate an inbound delivery notification in the buyer's logistics site system. Included within this inbound delivery notification can be product codes for products scheduled to be delivered. A product code can be associated with each inventory item to be received by the logistics site. The product code for the inventory can be electronically encoded using a bar code. This product code, in bar code format, for example, can be printed onto a label that is affixed to the inventory.

When the inventory reaches the logistics site, a worker can use a mobile device (e.g., mobile device 102) to read the bar code. The encoded identification information read by the mobile device can be sent from the mobile device using a network to a computer device at the logistics site. The computer device can compare the received encoded identification information with the product codes of the products expected to be delivered. The result of this comparison can be returned to the mobile device for display on the UI to the worker. The worker may approve the receipt of the inventory based on the results of the comparison and the approval can be transmitted to the computer device using the network. This confirmation response can be used to complete the process flow.

In another embodiment, a system to decode bar code information may use a fixed reader. For example, the reader may be mounted at a specific location at a receiving dock. Products can be received at the dock and loaded onto mobile platforms for placement into inventory. Bar code labels can be affixed to the received products either previously or at this point. The products can be loaded onto the mobile platforms so that the bar codes are accessible to the fixed bar code reader as the mobile platform travels by the bar code reader. The encoded identification information read by the bar code reader can then be sent using a network 104 to a computer device for further processing as described above. If the bar code information corresponds to product information for expected products, the system can complete the inventory receipt process. If the bar code information does not match the product information for expected products, an alert may be sent to a worker to intervene in the process.

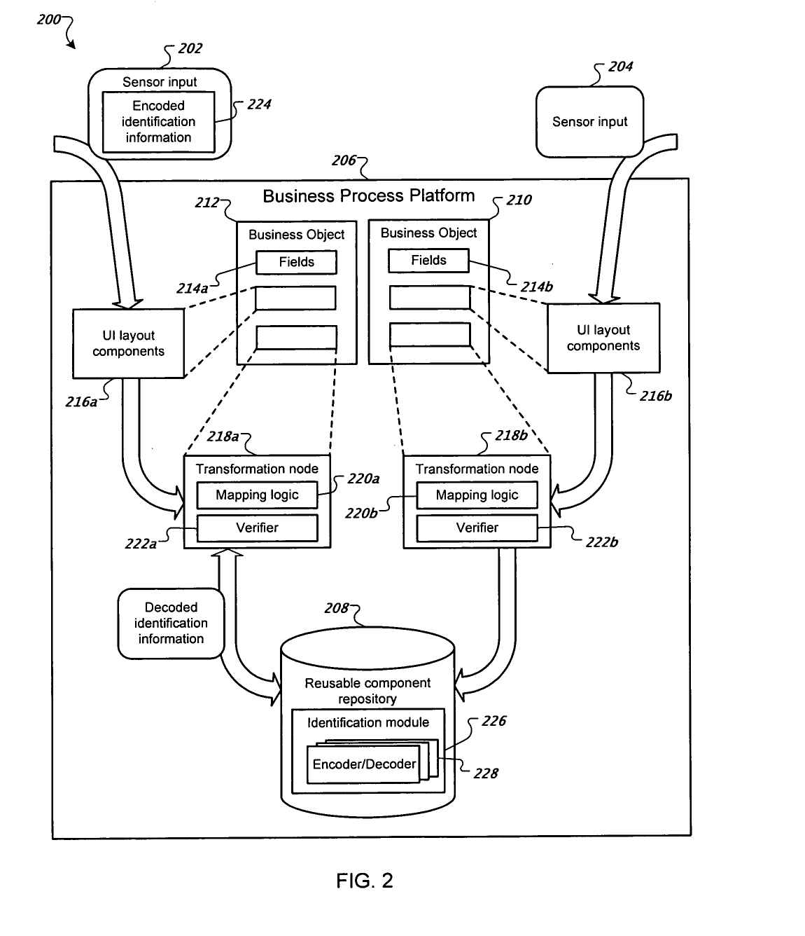

FIG. 2 is a block diagram of an exemplary system 200 that includes a reusable identifier module that decodes sensor input, examples of which are sensor input 202 and sensor input 204. The system 200 can include a service-oriented architecture platform, such as business process platform 206 that, in turn, can include a reusable component repository 208, and database objects, for example business object 210 and business object 212. In this example, business objects are computer program objects that abstract entities in the business that the program models. For example, an order entry program can include concepts such as orders, line items, and invoices. A business object may represent each of these concepts.

The business objects 210 and 212 include fields 214a and 214b, UI layout components 216a and 216b, and transformation nodes 218a and 218b, respectively. Each transformation node can include mapping logic 220a and 220b, and verifier 222a and 222b.

The mapping logic can map sensor input to fields in a business object. For example, fields in a business object can contain information about a product or service for which the business object is customized. In the case of an automotive parts supplier, for example, a field may be a product identification field, which may contain an article number (e.g., a part number) for an automobile replacement part. Another field may be the serial number of the specific replacement part.

UI layout components can include text labels for displaying information about received products into inventory, for example. In the case of the automotive replacement part, the UI layout component may be a text label displaying the text “part number”, where a part number value is received from the business object for display on the UI 118.

The transformation node 218a can be used to identify and pass encoded and/or decoded sensor data between the reusable components repository 208 and the business object 212. The transformation node 218a can use mapping logic 220a to assign the decoded sensor data to an appropriate field in the business object. The mapping logic 218a can be customized for each transformation node associated with a business object. For example, each business object may include different fields based on the requirements of the business object. The mapping logic may be configured so that the decoded information is placed in an appropriate field even if the fields vary from business object to business object.

The business process platform 206 can accept multiple types of sensor input. Sensor input 208 can include, but is not limited to, RFID or barcode information. For example, sensor input 202 that includes encoded identification information 224 from the bar code 108, as shown with reference to FIG. 1, can be read by mobile device 102. The encoded identification information 220 can be transmitted to the computer device 106 by the mobile device 102 using network 104.

The use of reusable identification module 226 can allow multiple types of sensor input to be decoded and encoded. As new technologies for sensor input become available, new functionality that can support the specifics of the encoding and decoding for the additional sensor input type may be added to the reusable identification module 226. Because the decoding and encoding functionality is centralized, other components of the business process platform 206 may not require significant modifications, which permits minimal system design changes to accommodate new sensor input technologies.

The mobile device 102 can send the encoded identification information 224 to the computer device 106 by encoding it using a communication protocol. Communication protocols may include, but are not limited to, Blue Tooth, WiFi and other wireless communication protocols. In another embodiment, a device used to read sensor input may be directly connected to a computer device using a cable. Communication protocols for the direct connect device may include but are not limited to Universal Serial Bus (USB), parallel port, bi-directional parallel port, RS-232 and other wired communication protocols.

The encoded identification information 224 of the sensor input 202 may be received by the UI layout component 216a of the business object 212. The particular business object can be selected based on the context of the process flow. For example, if the process flow is a “move” process flow, the business object may be an inventory business object that includes information regarding what stock should be placed at particular locations in a warehouse.

The UI layout component 216a may not contain the logic for decoding the sensor input 202 or for mapping the sensor input 202 to the business object 212. The UI layout component 216a can pass received sensor input 202 in the form of encoded identification information 224 to the transformation node 218a in the business object 212. In one embodiment, the transformation node 218a can handle all calls to and from the identification module 226 in the reusable component repository 208. In other embodiments, the business object itself may directly call and/or communicate with the identification module 226. For example, the business object can include code segments that reference encode/decode methods defined by the identification module 226.

The encode/decode methods may be encapsulated in encoder/decoder modules 228 included in the identification module 226. More specifically, the encoder/decoder module can include generic methods for encoding or decoding identification information based on information included in the encoded identification information 224 passed to the identification module 226. The encoded identification information 224 can be passed, using a standardized format, from the transformation node 218a to the identification module 226 as an encoded string with data fields separated by application identifiers (AI). The application identifier can be a prefix used to identify a definition and format of the data that follows it in the data field. Encoded strings are separated by AIs. In some cases, however, the encoded string associated with a particular AI can itself be composed of concatenated strings. In this case, a different delimiter string can be defined for the AI for that data field.

Each character is represented by a pattern of wide and narrow bars. A barcode symbology defines the technical details of a particular type of barcode: the width of the bars, character set, method of encoding, checksum specifications, etc. UCC/EAN-128 uses normal Code 128 barcodes, but formats the data in a standardized way to identify the type of information contained in the barcode.

For example, encoded identification information 224 can be a 1D bar code type of Uniform Code Council/European Article Numbering (UCC/EAN)-128, an industry standard defined and maintained by the Uniform Code Council. A bar code is comprised of a series of encoded characters. Each character is represented by a pattern of wide and narrow bars. Barcode symbology can define the technical details of a particular type of barcode (e.g., the width of the bars, character set, method of encoding, checksum specifications, etc.). UCC/EAN-128 formats the bar code data in a standardized way to identify the type of information contained in the barcode. A UCC/EAN-128 encoded identification string, as a concatenated string, can be as follows:

“]C10937000530]C100900370310”

where “]” is the start character, and “C1” is a control code specifying the type of information that is contained in the bar code. The transformation node 218a can use the control code as a version or technical variant for the bar code. An AI, “09” in this example, indicates that the data in the following field represents a global trade item number (GTIN). The GTIN is used to identify non-returnable trade items or a package of identical, non-returnable trade items. The GTIN identifies a particular item class, such as a particular kind of product (e.g., cell phone, PDA, etc.). Next is “]C” which is a delimiter used to separate the data fields. The AI “00” indicates that the data in the field to follow represents a serial shipping container code (SSCC). The SSCC is used to identify an inventory item than can be transported or stored and which needs to be tracked through the supply chain, for example, a carton or pallet.

The transformation node 218a can also pass a symbolic identifier, such as an symbolic identifier, (referred to as an Auto-ID type for purposes of this example), which can be used by the identification module 226 to identify the format of the received encoded identification information 224 (e.g., 1D bar code, 2D bar code, or RFID).

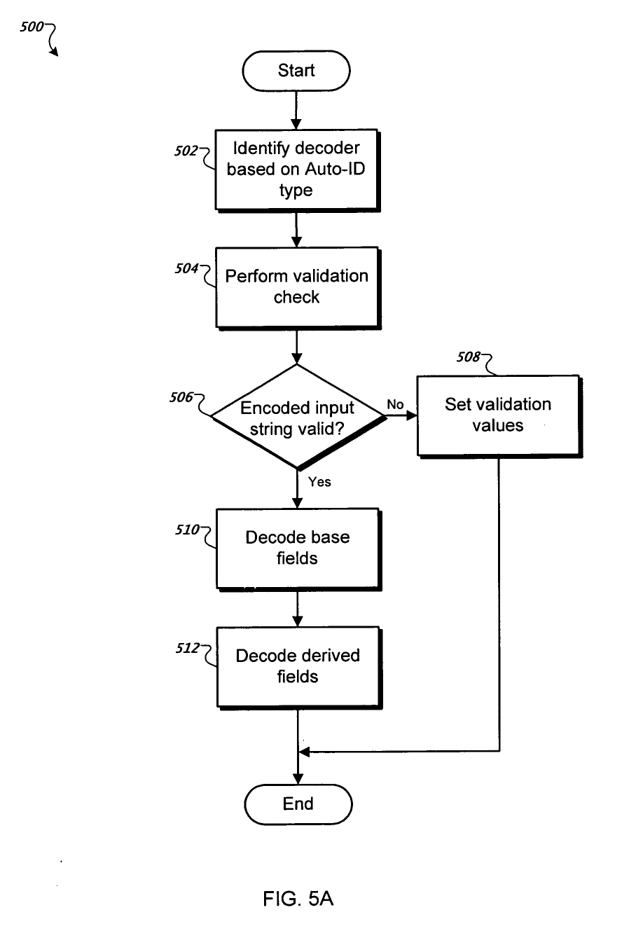

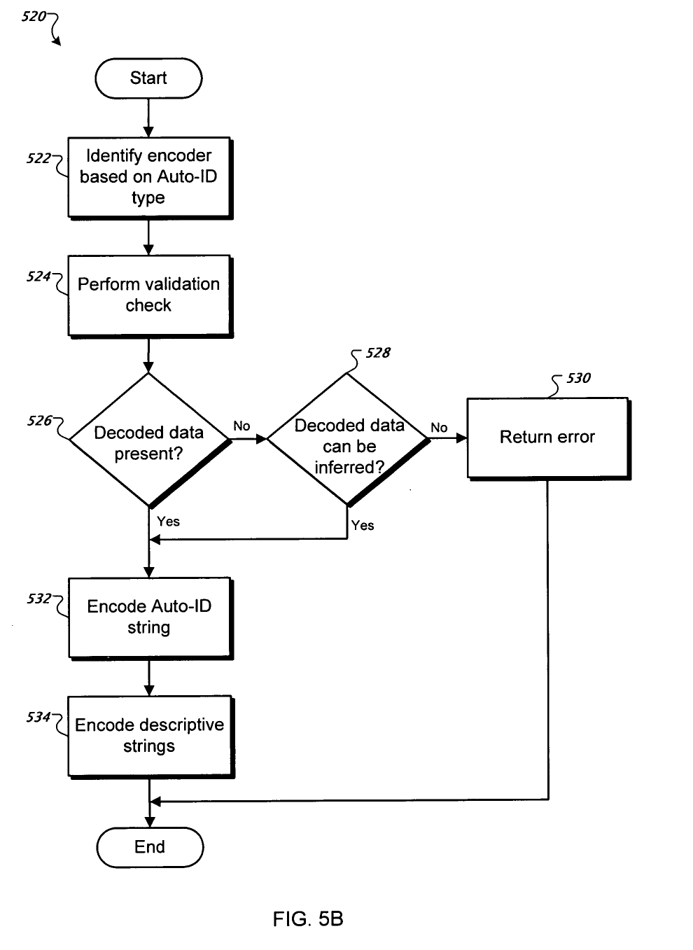

Optionally, the transformation node 218a can pass the version or technical variant symbolic code, an example of which was described above, to the identification module 226. The variant can be used to identify a variation of the format of the encoded identification information. For example, EAN-128 formats bar code data in a standardized way to identify the type of information contained in the barcode. A version or technical variant of EAN-128 is named FNC1 and its symbolic code value is “C1” as shown in the example above. Additionally, the identification module 226 can pass the concatenated string to the encoder/decoder module responsible for the processing of the Auto-ID type. The method by which the identification module 226 determines which encoder/decoder module to pass the encoded information to is described in more detail below with reference to FIG. 5A and FIG. 5B.

The encoder/decoder module can decode the identification information with the use of a customizing table containing a list of recognized AIs. Referencing the example above, the customizing table would have entries for each AI that could be used in the encoded and/or decoded identification information for the EAN-128 type bar code. A field identifier would be associated with each AI. For example, an AI of “09” would indicate that the field data value is for a GTIN.

In certain embodiments, after decoding by the identification module 226, the decoded identification information can be passed back to the transformation node 218a in the form of an internal table. Entries in the internal table would contain the AI and its decoded data. The data received by the transformation node 218a in the internal table can be passed to the mapping logic 220a, which maps the returned data into the appropriate fields 214a in the business object. The mapping logic 220a can include a customized table that associates each AI with the corresponding field in the business object.

Other information passed to the transformation node 218a from the identification module 226 can include a validation indicator and an error message. The identification module 226 may validate that the sensor input that has been received is complete and correct. This validation process can be included in the encoding/decoding processes performed by the encoding/decoding modules 228. The result of this validation is sent to the transformation node 214a along with any error message indicating the received sensor data is malformed or incorrect.

The verifier 222a in the transformation node 218a can contain an input field for each scanned sensor data value. The input field can contain the text value of the scanned sensor data for verification by the user. In the example above, the input field would contain the text:

(09)37000530(00)9900370310

where the AI values are contained within the parentheses. This represents the human readable form of the encoded bar code data. The result of the decoding of the sensor input can be displayed on the mobile device 102. This occurs once the decoded identification information has been received and processed by the transformation node 218a. The UI 118 of mobile device 102 can be sent a refresh UI command. The input fields of the verifier 222a can be displayed on the UI 118 of mobile device 102. For example, a text label displaying the text “GTIN” can be displayed with “37000530” displayed next to it. AIso the text label “SSCC” can be displayed with “9900370310” displayed next to it.

The user can then confirm the results, for example, by pressing a confirmation key on the keypad of the mobile device 102. Upon confirmation, the fields in the business object are updated and the user can then scan the bar code or RFID information on the next product. The user can also, for example, cancel the results by pressing a cancel button on the keypad of the mobile device 102. This may occur in the case when a read error has occurred and the business object fields, in this case, will not be updated. The user can then re-read the information associated with the product. In the event of a validation error, the business object fields will not be updated and the error message received by the transformation node 218a will be displayed on UI 118.

In certain embodiments, an editable field may be located next to each text label allowing the user to enter the correct value manually if the scanned value is in error.

The use of the reusable identification module 226 enables multiple heterogeneous business objects to receive sensor input. For example, additional sensor input 204 can be received by UI layout component 216a associated with a different business object 210. The encoded sensor input data can be sent to the transformation node 218b, which is associated with the different business object 210. In this way, multiple transformation nodes, due to the common accessibility of the identification module, can utilize the encoder/decoder modules, where each transformation node can be customized for a particular business object. This may permit business objects to have accessibility to the encoder/decoder modules, sending and receiving data specifically for its fields, without the need to include encoding/decoding logic in each business object.

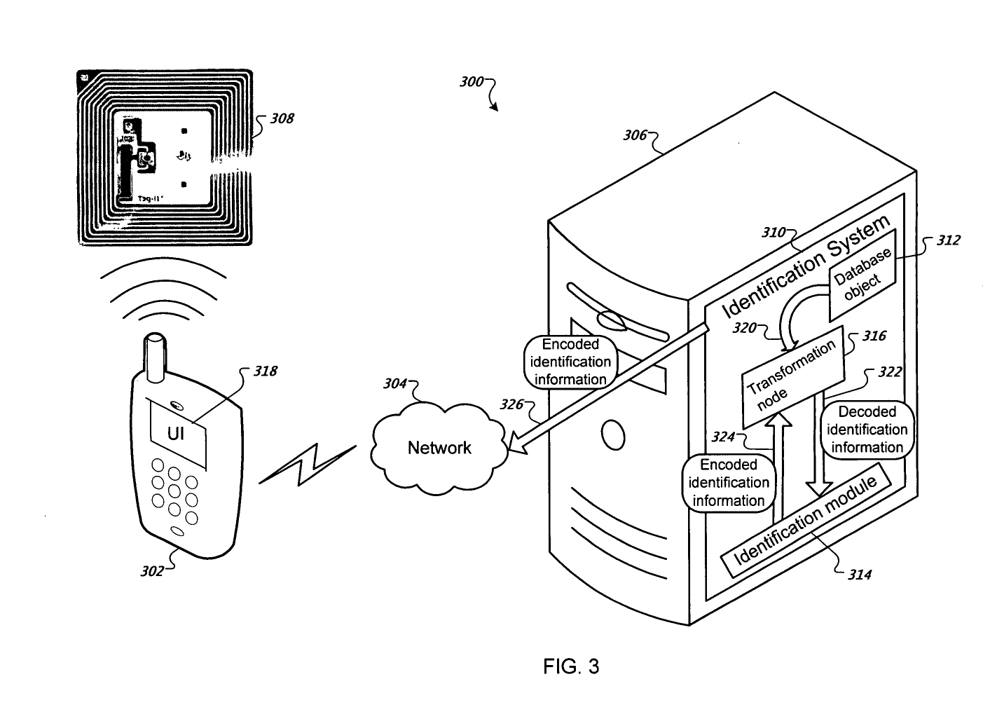

FIG. 3 is a block diagram of an exemplary system 300 to encode information on an RFID tag 308 using a mobile device 302. The system 300 includes the mobile device 302 having UI 318, a network 304, and a computer device 306.

As derived in association with FIG. 1, identification information to be encoded can include identifiers specifying symbolic codes associated with particular products or product containers. The computer device 306 can receive the identification information to encode on an RFID tag 308 using an input device (not shown). The computer device 306 can include an identification system 310, which can include a database object 312, an identification module 314, and a transformation node 316.

To initiate the encoding of the RFID tag 308, an output device (e.g., a monitor), which is not shown, can display prompts on a UI that direct a user to enter specific identification information for encoding into the RFID tag 308. A user can enter information into the computer device 306 using the input device (e.g., a keyboard), which is not shown. Identification information for encoding can include, but is not limited to, a GTIN and a SSCC, as described with reference to FIG. 2. The identification information for encoding can be stored in the database object 312 for future use by the identification system 310.

The identification system 310 can include modules (e.g., hardware or software) used for encoding the identification information provided by the user to the computer device 306. The transformation node 316 of the identification system 310 can receive the identification information from the database object 312, as indicated by arrow 320. The identification information may be stored in the database object 312 as decoded identification information, which is passed to the identification module 314, as indicated by arrow 322. The identification module 314 can receive the decoded identification information, encode it, and pass encoded identification information back to the transformation node 316, as indicated by arrow 324.

The transformation node 316, using network 304, as indicated by arrow 326, can send the encoded identification information to the mobile device 302. The UI 318 of mobile device 302 can display the information to be encoded in the RFID tag 308 on the UI 318 for verification by the user. If approved by the user, the mobile device 302 can transmit the encoded identification information to the RFID tag 308 using radio-frequency commands from an RFID transceiver, which can be included in the mobile device 302. The RFID tag 308 can contain a silicon chip and an antenna to enable it to receive and respond to the radio-frequency queries from the mobile device 302.

For example, a replacement part for an automobile is received for inventory at an automobile dealership. The receipt and tracking of this part can be entered into the inventory management system of the automobile dealership. A worker can enter identification information about the replacement part into a computer, which can be part of the inventory management system. The entry can be performed as was described above. A mobile device capable of programming an RFID tag can receive the encoded identification information. When the mobile device receives the encoded identification information for the replacement part, the mobile device can program the RFID tag with the identification information for the replacement part, and the worker can place the RFID tag on the replacement part.

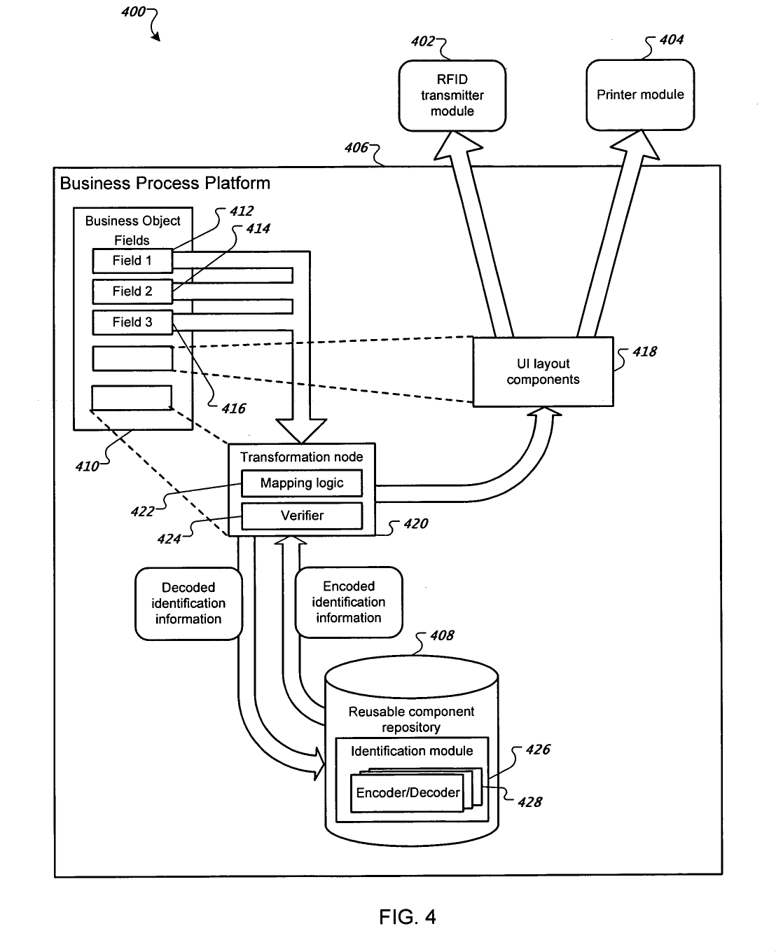

FIG. 4 is a block diagram of an exemplary system 400 that includes a reusable identifier module that encodes data for output to devices, examples of which include an RFID transmitter module 402 and a printer module 404. The system 400 can include a business process platform 406 that can include a reusable component repository 408, a database object, for example, business object 410. The business object 410 includes field 1 412, fields 2 414, field 3 416, UI layout component 418, and transformation node 420. As previously described, the transformation node 420 can include mapping logic 422 and verifier 424.

The transformation node 422, including mapping logic 422, and the UI layout components 418 function substantially similar to the transformation node 218a, including mapping logic 220a, and the UI layout components 216a, as described with reference to FIG. 2.

Just as the business process platform 406 can receive various types of sensor input, it can also output multiple Auto-ID types of encoded identification information. For example, identification information entered into the computer device 306 can be encoded by the identification system 310, as shown with reference to FIG. 3. Encoded identification information in a RFID format can be transmitted by network 304 to the mobile device 302 having an RFID transmitter module 402 that transmits the encoded identification information to the RFID tag 308 for storage using radio-frequency commands. The RFID tag 308 can contain a silicon chip and an antenna to enable it to receive and respond to the radio-frequency queries from the mobile device 302. In another example, the encoded identification information may be in a bar code format. The encoded identification information can be sent to the printer module 404, which can print a bar code label, which can be affixed to an inventory item, for example.

The use of the reusable identification module 426 enables multiple heterogeneous business objects to accept encoded identification information for use in identifying objects without embedding this functionality within each business object. The objects can be identified by coded labels containing the encoded identification information in printed form (e.g. a bar code) or by electronic parts that are programmed with the encoded identification information (e.g. an RFID tag). As new technologies for Auto-ID types and encoding schemes become available, new functionality for encoding can be added to the reusable identification module 426 for the additional Auto-ID type. The business process platform 406 may not require significant modifications, as is the case where new sensor input technologies are introduced.

The computer device 306 using network 304 can send encoded identification information to the mobile device 302 by encoding it using wired or wireless communication protocols. The identification information for encoding may be included in fields in a business object. As described with reference to FIG. 3, a user may enter identification information into the computer device 306 for storage in a database object 312. An example of a database object is business object 410. The business object 410 can contain the identification information in the field 1 412, field 2 414, and field 3 416. The business object 410 may not include the logic for encoding the identification information. The fields in the business object 410 can be mapped to the transformation node 422 using mapping logic 424.

The verifier 424 included in the transformation node 426 can verify the content of the information retrieved from the fields in the business object. The verifier 424 can contain a corresponding field for each business object field to be encoded. The verifier's field can include the text value of the data to be encoded for verification by the user. For example, field 1 412 can include data specifying a handling unit (HU) (e.g., packaging materials, such as cartons, pallets, etc.), field 2 414 can contain data specifying a BIN, and field 3 416 can include data specifying a quantity (QTY). The field value for field 1 412 is “MAAAA”, the field value for field 2 414 is “BBBBBB”, and the field value for field 3 416 is “CCCCCC”.

The data to be encoded can be displayed on the mobile device 102 prior to encoding for user confirmation. The input fields of the verifier 424 can be displayed on the UI 318 of mobile device 302. For example, a text label displaying the text “HU” can be displayed with “AAAAAAA” displayed next to it. The HU can be used for tracking items based on the materials (e.g., packaging materials like cartons and pallets).

The text label “BIN” can be displayed with “BBBBBB” displayed next to it. The text label “QTY” can be displayed with “CCCCCC” displayed next to it. The user can then confirm the data to be encoded, for example, by pressing a confirmation key on the keypad of the mobile device 302. Upon confirmation, encoding process will start. The user can also, for example, cancel the encoding process by pressing a cancel button on the keypad of the mobile device 302. This may occur in the case where erroneous data has been displayed to the user. In another embodiment, an editable field may be located next to each text label allowing the user to enter the correct value manually if the proposed data to be encoded is incorrect or incomplete.

The transformation node 420, upon user confirmation of the data to be encoded, can call the identification module 420 that includes encoder/decoder modules 428. The identification information can be retrieved from the business object fields, filed 1 412, field 2 414, and field 3 416, using the transformation node 420, and transmitted to the identification module 426 as a table containing field name and corresponding value pairs.

The transformation node 420 can also pass a symbolic identifier (again referred to as an Auto-ID type for the purpose of this example), which can be used by the identification module 426 to identify the format of the identification information to be encoded (i.e. 1D bar code, 2D bar code or RFID). Additionally, the transformation node 420 can pass the version or technical variant symbolic code, an example of which was shown with reference to FIG. 2, to the identification module 426.

Other information passed to the transformation node 420 can include a validation indicator and an error message. These results can be handled in a substantially similar way as was discussed with reference to FIG. 2.

The encoder/decoder module can encode the identification information with the use of a customizing table containing specific entries for different Auto-ID types. Referencing the example above, where the identification information to be encoded contains a symbolic code for a HU, a BIN and a QTY, the customizing table would have entries based on the Auto-ID type, for example a bar code, for how to encode each data field for the Auto-ID type. The table can include the AI code value for each data value supported by the Auto-ID type and variant. The encoded identification information is sent back to the transformation node 420 for output. The transformation node 420 can send the encoded identification information to the UI layout component 418, which can in turn, transmit the encoded identification information to a selected output device. For example, the data shown above can be encoded into an EAN-128 formatted bar code as follows:

WWXXAAAAAAYYBBBBBBZZCCCCCC

where XX, YY and ZZ are AIs and WW is the technical variant. This bar code can be sent to printer module 404, where a bar code label can be printed for an inventory item.

FIG. 5A is a flow chart of an exemplary method 500 for decoding received sensor data. The identification module 226 shown with reference to FIG. 2 can use the method 500. The method 500 begins by identifying the Auto-ID type to be decoded (step 502). Examples of Auto-ID types may include bar codes or RFIDs.

The encode/decode module that can be used is then identified based upon the Auto-ID type. The Auto-ID type may be sent to the identification module 226 by the transformation node 218a, as described in association with FIG. 2. The Auto-ID type may also be inferred from the input string to be decoded. For example, a 1D bar code of type category EAN-128 can be identified to the identification module 226 by the transformation node 218a. The encoding/decoding module included in the identification module 226 that is specifically designed for use with EAN-128 bar code types will be selected for the decoding of the identification information.

A validation check can be performed (step 504), where the input string is parsed according to the decoder logic for determination if the input string is valid (step 506). A list of AIs is retrieved from a customizing table for the Auto-ID type and variant, for example EAN-128 bar code. A bar code string is retrieved from the input string that may include more concatenated AIs. An example bar code string can be as follows:

“]C1D001234567890123456780147111”

The bar code string can be parsed, first reading the bar code prefix “]C1D”. This indicates that an EAN-128 type bar code is to be decoded. If the bar code prefix is not found, the input string is determined to be “non-bar code”, a validation error is indicated, validation values may be generated to specify the reasons for the failure (step 508), and the decoding method ends. If the bar code prefix is found, the string is then checked for a beginning prefix that indicates the bar code format, such as the EAN-128 bar code type used in this example. Next, the AI can be read after the bar code prefix. In this example, the AI is “00”. The AI “00” is checked against the customizing table, verifying that it is a valid application identifier for a SSCC. If the AI is not valid, a validation failure occurs, a validation error is indicated, validation values may be generated to specify the reasons for the failure (step 508), and the decoding method ends.

If the validation check is successful, base fields in the data string for the AI can be decoded by the selected encode/decode module of the identification module 226 (step 510). The base fields can include the information within the fields of the encoded data that was received from the sensor. The result of decoding the base fields can be generated parsed data, which can include a data field name and associated data value. For example, the base fields for SGTIN (Serialized Global Trade Item Number) bit-level encoding can include a company prefix, an indicator digit, an item reference, and a serial number. These fields are decoded

Next, derived fields are decoded (step 512). Derived fields can be generated data fields, which use the parsed data from step 510. For example, the derived field be a GTIN (Global Trade Item Number) plus serial number identity structure, which includes a single string built from the decode base fields. The string can contain the fields in a different order than received in the SGTIN bit-level encoding. In this derived field example, the string can include the indicator digit first, followed by the company prefix, the item reference, an additional check digit value that may be calculated by the encoding service, and the serial number. After step 510, the method 500 can end.

If the AI is valid, the data after the AI is read to determine the base fields and the derived fields. If the data length value for the data after the AI is predefined, the string of the predefined length is read. If the data length for the data after the AI is a variable, the data in the string is read up to a delimiter string defined for the AI being used. The string parsing process may end by verifying that the end of the bar code string has been reached. In the example above, the AI is “00” and the valid data for the AI is “123456789012345678.” This is the symbolic value for the SSCC field. This value can be returned to the transformation node 218a for input into the fields 214a in the business object 212. Since the end of the bar code string has not been reached, the method next reads the AI of “01”. This indicates an article number is encoded in the associated string. The method then reads the associated string and determines the symbolic representation for the article number to be “4711”. This value can also be returned to the transformation node 218a for input to the fields 214a in the business object 212. The end of the bar code string has been reached and the method ends.

FIG. 5B is a flow chart of an exemplary method 520 for encoding data for output. The identification module 426, shown in FIG. 4, can use the method 520. The method 520 begins by identifying the Auto-ID type (e.g., bar codes and RFID) to use to encode the identification information (step 522). The encode/decode module included in the identification module 426 is then identified based upon the Auto-ID type. This identification occurs in a substantially similar manner as in step 502 of method 500.

A validation check can be performed (step 524). A check is made to determine if all of the required data for encoding has been supplied to the identification module 426 by the transformation node 420. If the decoded data to be encoded is not all present (step 526), a check is then made to determine if the missing data can be inferred (step 528). For example, the missing data may be derived from the base fields as described in association with step 512 of FIG. 5A.

If the data cannot be inferred, the validation check fails, an error is returned (step 530), and the method 520 ends. If all of the required data for encoding has been supplied to the identification module 426 by the transformation node 420, the Auto-ID string can be encoded (step 532). If all of the required data has not been supplied but the missing data can be inferred, the Auto-ID string can also be encoded (step 532). Next, the descriptive strings can be encoded (step 534). The method 520 then ends.

The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. In some implementations, the processor 610 is a single-threaded processor. In other implementations, the processor 610 is a multi-threaded processor. The processor 610 is capable of processing instructions stored in the memory 620, or on the storage device 630. In some implementations, the processed instructions may generate graphical information for a user interface, on the input/output device 640.

The memory 620 stores information within the system 600. In some implementations, the memory 620 is a computer-readable medium. In some implementations, the memory 620 is a volatile memory unit. In other implementations, the memory 620 is a non-volatile memory unit.

In some implementations, the storage device 630 is a computer-readable medium. In various different implementations, the storage device 630 may be a floppy disk device, a hard disk device, an optical disk device, or a tape device.

The input/output device 640 provides input/output operations for the system 600. In some implementations, the input/output device 640 includes a keyboard and/or pointing device. In other implementations, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, using example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including using example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The components of the system can be connected by any form or medium of digital data communication such as a communication network. Examples of communication networks include, e.g., a LAN, a WAN, and the computers and networks forming the Internet.

A number of embodiments of the reusable identification feature have been described. Nevertheless, it will be understood that various modifications may be made without departing from the spirit and scope of the feature. For example, the transformation module can be a distinct object from the business object or it can be functionality that is incorporated into the business object, such as a method of the business object.

Additionally, although the input examples included RFID and bar codes, other input can be used. For example, a worker could enter verbal input by speaking into a microphone connected to the system. The verbal input could be converted to text for use in the system. In another example, the data could be retrieved from the business objects and encoded as verbal output. The system could play the computer-generated output so a worker can identify a stock or location after it is scanned by a RFID or bar code reader.

In other embodiments, the UI layout component accepts input from users and transmits it to the identifier module, which decodes the input for insertion into the fields of the business object.

In yet other embodiments, the identifier module is used in a verification process performed by workers. For example, the expected location of stock may be stored in a field of the business object. The worker may scan a bar code affixed to the stock and a bar code affixed to the location. The identification module may decode the scanned information and compare it to the expected location of that stock. If the stock is not in the expected location, instructions to move the stock to the expected location may be generated.

The verification process may be performed by workers using a mobile device. For example, the stock information and associated expected location information may be preloaded onto the mobile device. When a user scans the stock and location, this information can be compared with the previously stored information. In certain embodiments, the previously stored information may be stored in a simplified or “lite” version of the corresponding business object that typically stores the information. This lite business object can be stored on the mobile device and synchronized with the full implementation of the business object stored in the systems running the full system.

Alternatively, the information may not be stored on the mobile device, but may remain on a substantially fixed system. The user can scan stock and its location, store the scanned information, and then synchronize the information with the substantially fixed system to determine if any of the stock was misplaced. Accordingly, other embodiments are within the scope of the following claims.

What is claimed is:

1. A method of receiving identification information identifying a physical object, the method comprising:
receiving identification information from an identification capture system that obtains the identification information from an identification component associated with a physical object, the identification information identifying the physical object to which the identification component has been associated and encoded in a format compatible with an input device for the identification capture system;
determining a software object predefined by a process flow to receive the identifier information, the software object having at least one field to store the identifier information, and identifying a format used for the at least one software object field; and
converting the format compatible with the input device of the identification capture system into the format of the at least one software object field, and forwarding the identification information in the converted format to the at least one software object field for storage.

2. The method of claim 1, wherein the input device of the identification capture system comprises a bar code reader.

3. The method of claim 2, wherein the format compatible with the bar code reader comprises bar codes selected from a group consisting of linear bar codes, stacked bar codes, and 2D bar codes.

4. The method of claim 2, wherein the identification component comprises a label printed with a bar code.

5. The method of claim 1, wherein the input device of the identification capture system comprises an RFID (radio frequency identification) reader.

6. The method of claim 5, wherein the identification component comprises an RFID tag.

7. The method of claim 1, wherein the identification capture system comprises a voice recognition system and the identification component comprises a human readable label that a worker can read into the voice recognition system.

8. The method of claim 1, further comprising executing mapping logic to map portions of the identification information to corresponding software object fields if the software object includes more than one software object field.

9. The method of claim 1, wherein the conversion identifies a type of the format compatible with the input device of the identification capture system using header information included in the received identification information.

10. The method of claim 9, wherein the conversion further comprises using the identified type and an index comprising format conversions to determine how to convert the format compatible with the input device into the format of the at least one software object field.

11. The method of claim 1, further comprising validating that the identification information received from the identification capture system is complete by comparing the format of the received identification with an expected format of the identification information.

12. The method of claim 11, further comprising deriving additional information to supplement the identification information if the identification information is incomplete.

13. The method of claim 1, wherein the conversion is performed by one of multiple decoders each configured to perform different conversions.

14. The method of claim 13, wherein the conversion further comprises using header information included in the identification information compatible with the input device to identify a decoder configured to decode the identification information.

15. The method of claim 1, wherein the physical object identified by the identification information is a location, stock, or storage receptacles used to contain or move the stock.

16. The method of claim 1, further comprising storing previously received identification information that identifies stock and previously received corresponding identification information that identifies an expected location for the stock.

17. The method of claim 16, further comprising verifying whether the identified stock is stored at the expected location by comparing the identification information received from the identification capture system with the previously stored identification information that identifies the expected location, wherein the physical object specified by the identification information received from the identification capture system comprises the location, the stock that is to be verified, or a combination thereof.

18. A computer-implemented method for transmitting identification information identifying a physical object, the method comprising:
determining a software object specified by a process flow, the software object having one or more fields to store identification information to be encoded in an identification component using an identification generation system, the identification information to identify a physical object that is associated with the identification component;
receiving the identification information in a format compatible with the one or more software object fields, and identifying a format used by the identification generation system to encode the identification information in the identification component; and
converting the format compatible with the one or more software object fields into the format used by the identification generation system, and forwarding the converted identification information to the identification generation system for encoding in the identification component.

19. The method of claim 18, wherein the identification information is encoded into a bar code format or an RFID format.

20. A system for receiving and transmitting identification information identifying a physical object, the system comprising:
a sensor system to receive identification information encoded in an identification component associated with a physical object and to transmit the identification information to the identification component, the identification information identifying the physical object to which the identification component is associated;
an encoder to receive the identification information from a software object determined from multiple software objects, the software object having one or more fields to store the identification information in a first format compatible with the software object fields, and to encode the first format into a predetermined second format used by the sensor system to transmit the identification information to the identification component; and
a decoder to determine the software object from multiple software objects to receive the identification information encoded the second format from the sensor system, and to decode the second format into the first format used by the one or more fields of the determined software object.
